(19) United States
(12) Patent Application Publication
(10) Pub. No.: US 2005/0072819 A1
(43) Pub. Date: Apr. 7, 2005

(54) Retractable tether system for cellular phone

(76) Inventors: Wilfredo Maldonado, New York, NY (US); Sandra Bracero, Bronx, NY (US)

Correspondence Address: Richard C. Litman;LITMAN LAW OFFICES, LTD., P.O. Box 15035, Arlington, VA, 22215, US

(21) Appl. No.: 10/941,989

(22) Filed: Sep. 16, 2004

Related U.S. Application Data
(60) Provisional application No. 60/502,978, filed on Sep. 16, 2003.

(51) Int. Cl. H04B 1/40; B65H 75/40; A45F 5/00

(52) U.S. Cl. 224/162; 224/269; 224/930

(57) ABSTRACT

The retractable tether for a cellular phone includes a Nylon cord attached at one end by a clip to a chain which, in turn, is 30 inches in length and is held in a push button release, spring-activated retracting reel within a case which has a clip for attachment to the user's belt or other article of clothing. The release mechanism on the case allows the user to pull the cord to the desired length during use by pushing a release button. The release mechanism has a brake for holding the phone at a desired length for use, for example, on a table for use of the telephone with the user's hands free without retraction of the tether. The tether may then be retracted, along with the telephone, by pushing a button on the release mechanism.

### CROSS-REFERENCE TO RELATED APPLICATION

This application claims the benefit of U.S. Provisional Patent Application Ser. No. 60/502,978, filed Sep. 16, 2003.

### BACKGROUND OF THE INVENTION

1. Field of the Invention

The present invention relates to retractable reel systems. More particularly, the present invention relates to a retractable reel mounted on an article of clothing as a tether for a cellular telephone.

2. Description of the Related Art

The use of retractable reels for tethering an object or pet is well known. These reels are generally spring-loaded so as to allow the tethered object to travel or be pulled away from the reel for up to a maximum distance, while providing a retracting rewinding force on the tether such that the tether will rewind on the reel when outward pulling force on the tether is released. It is also known to provide spring-loaded tape measure reels which are retractable and which have a braking and release mechanism to allow extension of the tape measure from a reel to a selected extended position upon pushing a release button and pulling the end of the tape from the spring-loaded reel in the casing, maintaining the tape measure at that position by releasing the button, and retrieving the tape by pushing the release button and allowing the spring-loaded reel to retract the tape measure into the casing. The tape measure is maintained at a desired position by a brake acting on the reel within the case. The brake is released by pushing the release button which allows the extension or rewind of the tape. Chalk string retractable reels having brakes are also known.

The use of cellular telephones is widespread. The telephone is typically held in carrying case or holster mounted on the users belt when not in use. A cellular telephone may easily fall from the case when the user is bending over. The cellular telephone may also be dropped by the hand of the user when in use. Dropping the telephone may result in loss or damage to the telephone, particularly when the telephone is dropped into water.

Clothing-mounted cellular telephone retractable tethers are known, but suffer from the drawback that retracting tension is continually applied to the telephone during use. This precludes the telephone from being pulled away from the retractable reel and placed on a table or other support during use, freeing the user's hands for other activities. It would be desirable to provide a clothing-mounted retractable cellular telephone tether system which has a push button brake release system which allows the telephone to be removed from the vicinity of the retractable reel and held at a desired length, such as for placement on a table for hands-free use, and then retracted to the stored length for placement in the holster.

Thus a cord attachment to clothing for cell phone solving the aforementioned problems is desired.

### SUMMARY OF THE INVENTION

The retractable tether for a cellular phone of the present invention includes a Nylon cord attached at one end by a clip to a chain which, in turn, is attached by a clip to a cellular phone. The Nylon cord is about 30 inches in length and is held in a push button release, spring-activated retracting reel within a case which has a clip for attachment to the user's belt or other article of clothing. The release mechanism on the case allows the user to pull the cord to the desired length during use by pushing a release button. The release mechanism has a brake for holding the phone at a desired length for use, for example, on a table for use of the telephone with the user's hands free without retraction of the tether.

The tether may then be retracted, along with the telephone, by pushing a button the release mechanism on the case to release the brake and allow retraction of the cord. The tether chain is of such a length that the phone may reach from the case of the retractable reel to the phone when the phone is carried in a holster mounted, for example, on the user's belt. The effective length of the tether chain may be adjusted by removing the clip and placing it in another link in the chain. A bead-type chain such as a key chain may also be used as a tether chain. The tether system keeps the telephone from falling to the ground or into water from the carrying holster, or from the hand during use, avoiding damage to the telephone.

It is an aspect of the invention to provide improved elements and arrangements thereof for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is a perspective view of a retractable tether system for a cellular telephone according to the present invention.

FIG. 2 is a rear breakaway view of the casing and retractable reel of the tether system of the present invention as attached to a cellular telephone.

FIG. 3 is a side view of the retractable tether system of FIG. 1.

FIG. 4 is an environmental perspective view of the retractable tether system of FIG. 1 within the reel casing clipped to a belt and the cellular telephone held in hand near the holster.

FIG. 5 is a perspective view of the present invention similar to that of FIG. 1 where a ball or “key chain” type chain is employed.

Similar reference characters denote corresponding features consistently throughout the attached drawings.

### DETAILED DESCRIPTION OF THE PREFERRED EMBODIMENTS

The present invention a clothing-mounted retractable cellular telephone tether system which has a push button brake release system which allows the telephone to be removed from the vicinity of the retractable reel and held at a desired length, such as for placement on a table for hands-free use, and then retracted to the stored length for placement in the holster. The tether system includes a retractable Nylon cord and a tether chain having an adjustable snap for linking the retracted tether cord to the storage holster when not in use.

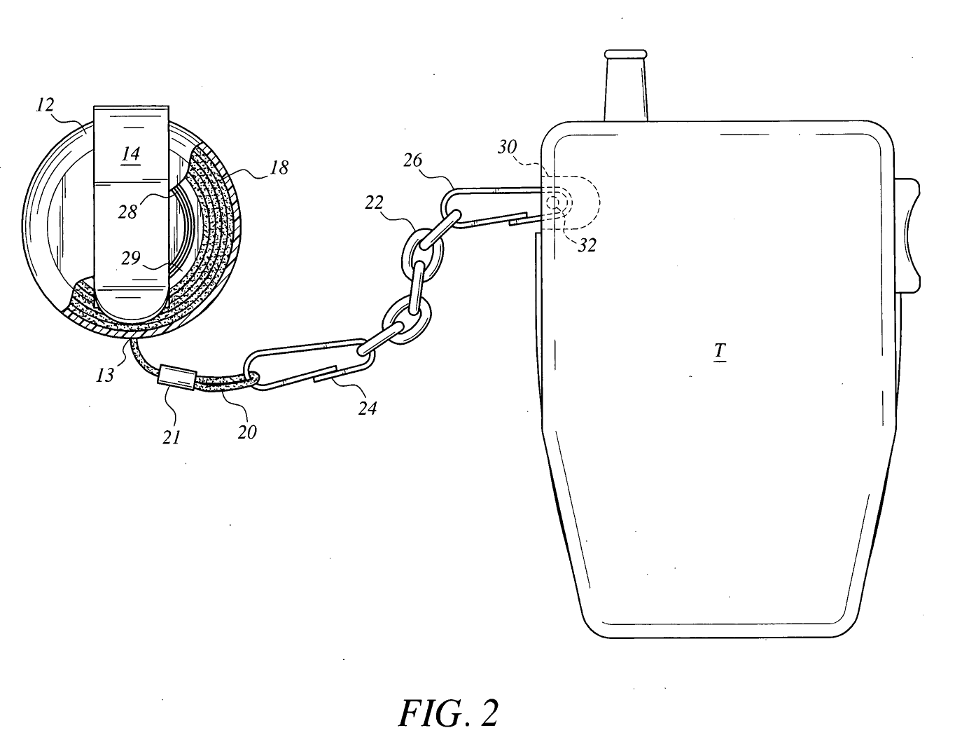

Referring to the Figures, there is shown a retractable tether system for a cellular telephone generally referred to as reference number 10. Tether system 10 has a cylindrical reel casing 12 having a back mounted casing clip 14, a central tether release button 16. Cylindrical reel casing 12 also defines a peripheral port 13 (see FIG. 2) located along its periphery for the release and retraction of the tether. Retractable tether cord 18 has a cord end loop 20 formed at its free end by securing grommet 21. Tether chain 22 is releasably connected at one end to cord end loop 20 by cord clip 24. Tether chain 22 has a telephone clip 26 at its free end for attachment to cellular telephone T.

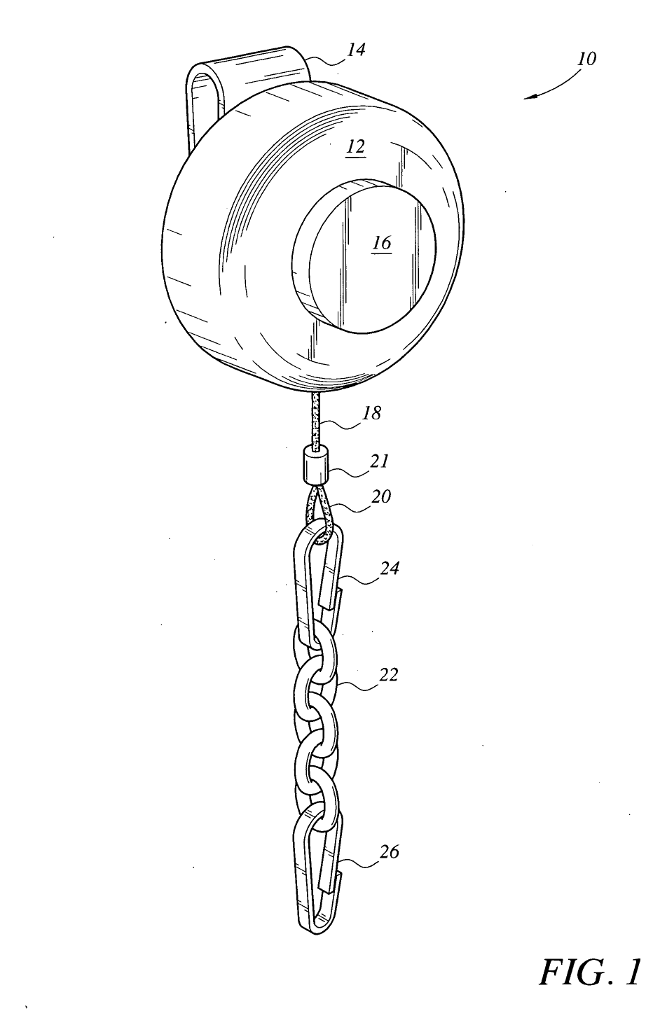

As best seen in FIG. 2, reel casing 12 has a retraction coil spring 28 acting on reel 29 holding tether cord 18. Retraction coil spring 28 is coaxial with and attached within reel 29 in a conventional manner. A brake (not shown) is applied to the reel to maintain the reel at a given position. Upon pushing release button 16 (see FIG. 1), the brake is released, allowing reel 29 to turn. Tether cord 18 is attached to the reel 29 within reel casing 12 and has a free end extending out of the peripheral port 13 of reel casing 12. If outward pulling force is applied to the tether cord 18 at its free end, the reel may be unwound while coil spring 28 is wound.

If the tether cord 18 is released from the unwound position, the wound coil spring acts to turn the reel to retract the cord. This type of mechanism is well known as described, for example in U.S. Pat. No. 4,068,383 to Krebs, the disclosure of which is hereby incorporated by reference. A ratcheting type retracting reel may also be employed in which the tape or cord is freely pulled from the reel without pushing a release button, but, upon pushing a button, the tape or cord is retracted onto the reel by action of a coiled spring. This type of mechanism is also well known as described, for example, in U.S. Patent Publication No. US 2002/0040945 A1 of Stepancich et al., the disclosure of which is hereby incorporated by reference.

As illustrated, telephone T has a telephone clip receiver cavity 30 having a clip retaining post 32 to which telephone clip 26 attaches for removable attachment of tether chain 22. An alternative attachment point may be made by installing an eyelet connector in the telephone case in a known manner.

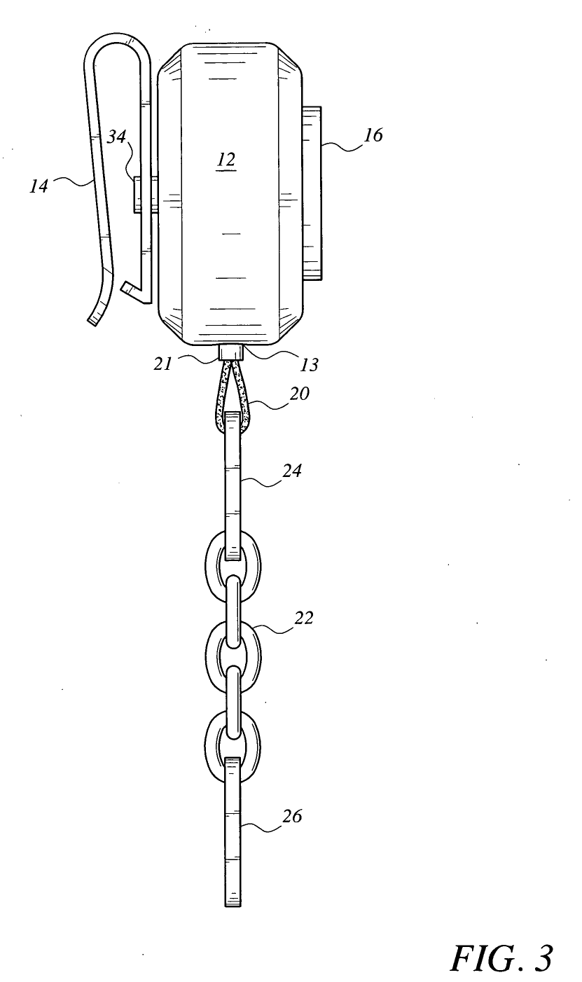

As best seen in FIG. 3, casing clip 14 is mounted on the rear of case 12 by casing clip support 34. In this view the tether cord is fully retracted into case 12 at its peripheral port 13 up to grommet 21.

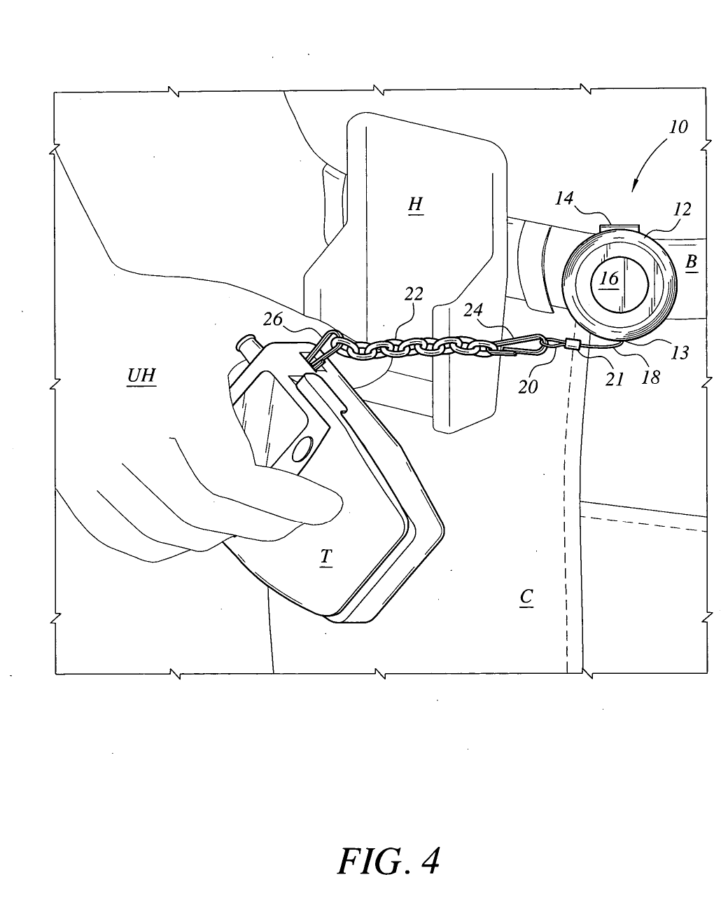

Referring to FIG. 4, reel casing 12 is attached to belt B of clothing C of the user by clip 14 at a point spaced from storage holster H, also clipped or other wise attached to the belt B. The reel casing 12 is located within the length of chain 22 such that the telephone T may be stored in holster H without cord 18 being withdrawn from the casing 12. Chain 22 may be of any chosen length desired, depending on where the user wishes to clip the reel casing 12 on clothing C. As illustrated, the user is holding the telephone T in one hand, and is in the process of withdrawing the telephone for use or returning the telephone to holster H, while the thumb of the other hand (shown in ghost lines) is pressed against the release button 16 of the tether system 10, the tether cord 18 extending from casing 12. The tether cord is preferably about 30 inches long for convenient use when holding near the ear or placing on a nearby table. The clip 24 also allows for easy disconnection of the telephone from the tether cord 18 for use where it is inconvenient to use both hands.

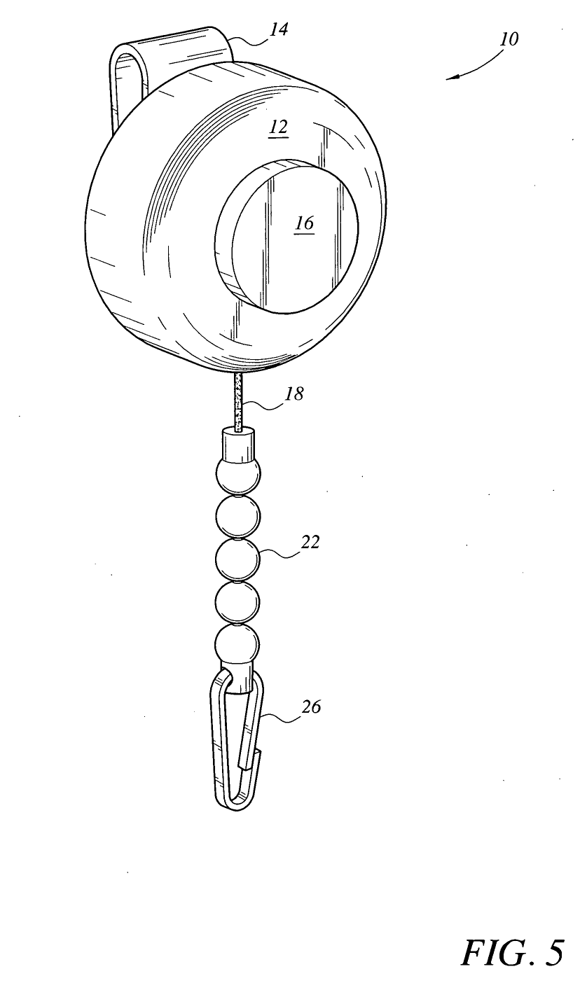

Referring to FIG. 5, a bead or “key chain” type chain is substituted for the link type of chain 22 in the tether system 10. Also, the chain 22 is shown connected directly to the free end of tether cord 18. Any type of chain configuration may be employed as chain 22 of the present invention.

In operation, the user removes the telephone T from holster H by grasping with hand H. The telephone T is then pulled to the point of use while the user's thumb or finger presses against button 16, allowing tether cord 18 to unwind from reel 29 and out casing 12 through peripheral port 13. When the telephone is at the point of use, the thumb or finger is removed from release button 16 braking the reel 29 and removing any retraction tension exerted by spring 28 from the tether cord. Once the user is ready to return the telephone to the holster, he once again presses the button 16, releasing the brake and allowing the coil spring 28 to turn reel 29, thus retracting the cord 18 onto the reel for storage in casing 12. The telephone is then placed in the holster for storage.

It is to be understood that the present invention is not limited to the embodiment described above, but encompasses any and all embodiments within the scope of the following claims.

1. A retractable tether system for a cellular telephone comprising:
a generally cylindrical reel casing having a circumferential tether port;
a clip for attaching said reel casing to an article of clothing;
said reel casing having a reel having a central axis, a coil spring attached to said reel casing and said reel and located within and coaxial with said reel, a releasable tether brake acting on said reel, and a tether brake release button located on said casing;
a retractable tether cord mounted on said reel and having a free end so as to wind and unwind from said reel and through said tether port; and
a clip attached to said free end of said tether cord for engaging a cellular telephone.

2. The retractable tether system of claim 1, further comprising a chain attached to said free end of said tether cord, said clip being attached to the free end of said chain, said chain being of sufficient length to extend between said cellular telephone when mounted in a carrying holster and said reel casing when mounted on the article of clothing.

3. The retractable tether system of claim 2, said free end of said tether cord forming an end loop secured by a securing grommet.

4. The retractable tether system of claim 2, said reel casing having a back mounted clip for attachment to an article of clothing.

5. The retractable tether system of claim 4, wherein said clip is a belt clip for attachment to a user's belt.

6. A retractable tether system in combination with a cellular telephone comprising:
a generally cylindrical reel casing having a circumferential tether port;
a clip for attaching said reel casing to an article of clothing;
said reel casing having a reel having a central axis, a coil spring attached to said reel casing and said reel and located within and coaxial with said reel, a releasable tether brake acting on said reel, and a tether brake release button located on said casing;
a retractable tether cord mounted on said reel and having a free end so as to wind and unwind from said reel and through said tether port; and
a clip attached to said free end of said tether cord for engaging said cellular telephone.

7. The retractable tether system and cellular telephone of claim 6, further comprising a chain attached to said free end of said tether cord, said clip being attached to the free end of said chain, said chain being of sufficient length to extend between said cellular telephone when mounted in a carrying holster and said reel casing when mounted on the article of clothing.

8. The retractable tether system and cellular telephone of claim 6, said cellular telephone defining a clip receiver cavity having a clip retaining post for receiving said clip attached to said free end of said tether cord.

9. The retractable tether system and cellular telephone of claim 7, said cellular telephone defining a clip receiver cavity having a clip retaining post for receiving said clip attached to said free end of said chain.

10. The retractable tether system of claim 9, said reel casing having a back mounted clip for attachment to an article of clothing.

11. The retractable tether system of claim 10, wherein said clip is a belt clip for attachment to a user's belt.

12. A retractable tether system for a cellular telephone comprising:
a generally cylindrical reel casing having a circumferential tether port;
a clip for attaching said reel casing to an article of clothing;
said reel casing having a reel having a central axis, a coil spring attached to said reel casing and said reel and located within and coaxial with said reel, a releasable tether brake acting on said reel, and a tether brake release button located on said casing;
a retractable tether cord mounted on said reel and having a free end so as to wind and unwind from said reel and through said tether port;
a clip attached to said free end of said tether cord for engaging a cellular telephone; and
a chain attached to said free end of said tether cord, said clip being attached to the free end of said chain, said chain being of sufficient length to extend between said cellular telephone when mounted in a carrying holster and said reel casing when mounted on the article of clothing;
said reel casing having a back mounted clip for attachment to an article of clothing.
